(19) United States
(12) Patent Application Publication
(10) Pub. No.: US 2007/0265780 A1
(43) Pub. Date: Nov. 15, 2007

(54) System and method for predicting future rail temperature

(76) Inventors: Kevin Kesler, Silver Spring, MD (US); Yu-Jiang Zhang, Springfield, VA (US)

Correspondence Address: NIXON PEABODY, LLP, 401 9TH STREET, NW, SUITE 900, WASHINGTON, DC, 20004-2128, US

(21) Appl. No.: 11/785,923

(22) Filed: Apr. 20, 2007

Related U.S. Application Data
(60) Provisional application No. 60/793,631, filed on Apr. 21, 2006.

(51) Int. Cl. G06F 19/00; B61B 12/00

(52) U.S. Cl. 702/3; 104/307

(57) ABSTRACT

A system and method for predicting future rail temperature for a rail of a railroad track, the system including a weather data source that provides current and forecasted meteorological data, a database that retrievably stores the meteorological data from the weather data source, and a processor that processes the meteorological data to calculate and output a future rail temperature for a future time based on the meteorological data, accounting for heat transfer characteristics of the rail. In one embodiment, the processor may be implemented to calculate the future rail temperature by determining a rate of change in rail temperature over time, and integrating the rate of change in rail temperature over time.

This application claims priority to U.S. Provisional Application No. 60/793,631 filed Apr. 21, 2006, the contents of which are incorporated herein by reference.

### BACKGROUND OF THE INVENTION

1. Field of the Invention

The present invention relates to systems and methods for determining rail temperature based on meteorological data. In particular, the present invention relates to a system and method for predicting future rail temperature based on meteorological data.

2. Description of Related Art

Derailment is a significant problem in the railroad industry. One important contributor to derailments is rail buckling. Rail buckling typically occurs due to high temperature of the rail, which causes the rail to expand. In extreme cases which have been reported in literature, rail temperature of up to 70° C. has been observed which causes the rail material, typically steel, to expand. Because rails of railroad tracks are substantially continuous and welded together, such expansion causes internal stress build-up along the rail, thereby increasing the likelihood that the rail will buckle to relieve the internal stress. Of course, any increase in temperature in excess of the rail neutral temperature will case the rail to expand, thereby increasing the likelihood of rail buckling. Whether rail buckling actually occurs depends on various factors such as the neutral temperature and condition of the rail, and supporting structures such as ties, etc. However, high rail temperatures have been found to be an important factor.

U.S. Patent Application No. 2005/0010365 to Chapman et al. discloses a method for predicting the variation in temperature along a survey route including a rail network. The publication discloses that the method includes using location specific geographical parameters, obtaining actual and forecast meteorological data, and predicting the temperature at each location based on such data. The meteorological data used to predict temperature calculated for each location includes air temperature, dew-point, precipitation, cloud cover, cloud type and wind speed. The reference discloses calculation and importance of a sky-view factor in making such predictions.

However, the system disclosed in Chapman et al. is primarily directed to predicting surface temperatures for road surfaces to determine the likelihood of ice developing on the road surfaces. The disclosed system is not directed to rails of railroad tracks, and cannot predict occurrence of high rail temperature, which causes expansion in the rails and increases the likelihood of rail buckling. In addition, such systems designed for predicting surface temperatures for road surfaces cannot adequately predict the rail temperature which may substantially differ from surface road conditions. In this regard, such systems do not provide rail temperature predictions with sufficient accuracy to allow it to be used as a basis for determining the likelihood of rail buckling.

Presently, ambient air temperatures are used by the railroads to predict the possibility of rail buckling. When ambient air temperatures of a particular geographical area or region are forecasted to exceed a predetermined temperature, for example, 90° F., track or rail warnings and slow orders are issued. The slow orders reduce the speed of the rail vehicles traveling in the geographical area for which the order is issued, thereby reducing the likelihood of derailments. These slow orders must be issued several hours in advance of the expected time when the ambient air temperature is forecasted to exceed a predetermined temperature. This is required in order to allow train operators and logistical support to make corresponding adjustments in view of the slow order.

However, issuance of slow orders effectively reduces the utilization of the railroad, and thus, causes the railroad to be underutilized. In addition, when such slow orders are issued, the railroad companies often dispatch inspectors to measure actual rail temperatures to determine actual likelihood of buckling. This is desirable because air temperatures do not accurately reflect the actual rail temperatures. Of course, such manual verification is costly, and adds additional expense to railroad operations.

Therefore, there still exists an unfulfilled need for a system and method that can predict future rail temperatures more accurately. There also still exists an unfulfilled need for a system and method that can predict future rail temperatures with sufficient accuracy to allow issuance of slow orders, while minimizing issuance of unnecessary slow orders that add cost to railroad operations.

### SUMMARY OF THE INVENTION

It has been found that general ambient air temperature is not a very good indicator for predicting the possibility of rail buckling. The rise in rail temperature is not linearly related to ambient air temperature. For example, the rail temperature can be significantly higher than air temperature on a sunny day, and can be the substantially the same as the air temperature on an overcast/windy day. In this regard, rail temperatures can vary substantially from the air temperatures. Differences of up to approximately 18° C. between the rail temperature and the ambient air temperature have been observed and differences up to 30° C. have been reported. Thus, due to the potentially large differences between the rail temperature and the ambient air temperature, not all slow orders are necessary. More importantly, under certain conditions, slow orders are not issued although the chance of rail buckling is relatively high.

In view of the above, the present invention is directed to a system and method for predicting rail temperature using real time meteorological data to allow accurate warnings to be issued regarding possible rail buckling, or other weather related rail conditions. In the preferred implementation, the meteorological data that is used for prediction includes time, air temperature, wind condition, and sun radiation. Preferably, the system and method of the present invention utilizes such meteorological data to predict the maximum rail temperature, as well as the time of day when the maximum temperature will occur.

Thus, the system and method in accordance with the present invention allows railroad companies to obtain accurate predictions of rail temperature, and allows the railroad companies to issue slow train operation orders more accurately, thereby enhancing safety while reducing operation costs and under-utilization attributed to unnecessary slow train operation orders.

In view of the foregoing, an advantage of the present invention is in providing a system and method that can predict rail temperatures.

Another advantage of the present invention is in providing a system and method that can predict rail temperatures with sufficient accuracy to allow issuance of slow orders, while minimizing issuance of unnecessary slow orders that add cost to railroad operations.

Therefore, in accordance with one aspect of the present invention, a system for predicting future rail temperature for a rail of a railroad track is provided, the system comprising at least one weather data source that provides current and forecasted meteorological data, a database that retrievably stores the meteorological data from the weather data source, and a processor that processes the meteorological data to calculate and output a future rail temperature for a future time based on the meteorological data, accounting for heat transfer characteristics of the rail. The heat transfer characteristics of the rail may include solar absorptivity of the rail, emissivity of the rail, specific heat of the rail, area of the rail surface, and/or volume of the rail. In this regard, the processor may be implemented to calculate the future rail temperature by determining a rate of change in rail temperature over time, and integrating the rate of change in rail temperature over time.

In another embodiment, the system includes a warning module adapted to generate a warning signal based on the calculated future rail temperature that is indicative of likelihood of the rail buckling at a future time. Preferably, the weather data source periodically updates the meteorological data, and the processor updates the calculated future rail temperature based on the updated meteorological data. In one implementation, the processor calculates the future rail temperature further based on an energy equilibrium model for the rail.

In yet another embodiment, the system may include an optional temperature sensor that measures the actual temperature of the rail at an instance in time, and the processor may be implemented to update the predicted future rail temperature using the actual temperature measured. The processor in other embodiments may be further adapted to process the meteorological data to estimate current rail temperature for use in calculation of the future rail temperature. A weather station may also be provided in the system which verifies accuracy of the forecasts of the at least one weather data source.

In accordance with another aspect of the present invention, a method for predicting future rail temperature for a rail of a railroad track is provided, the method comprising receiving current meteorological data, receiving forecasted meteorological data, and processing the received current and forecasted meteorological data to calculate a future rail temperature for a future time based on the meteorological data, accounting for heat transfer characteristics of the rail. In one embodiment, the calculation the future rail temperature may include determining a rate of change in rail temperature over time, and integrating the rate of change in rail temperature over time.

Another embodiment of the present method may include generating a warning based on the calculated future rail temperature to indicate the likelihood of the rail buckling at a future time. In another embodiment, the method also includes periodically receiving updated forecasted meteorological data, and updating the calculated future rail temperature based on the updated forecasted meteorological data. In still another embodiment, the calculation of the future rail temperature is attained using an energy equilibrium model for the rail that accounts for heat transfer characteristics of the rail.

Furthermore, the method in accordance with another embodiment may include measuring an actual temperature of the rail, and updating the predicted future rail temperature using the measured actual temperature of the rail. In another embodiment, the method may also include processing the meteorological data to estimate current rail temperature, and using the estimated current rail temperature to calculate the future rail temperature.

In accordance with yet another aspect of the present invention, a computer readable medium with instructions for predicting future rail temperature for a rail of a railroad track is also provided.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a rail temperature prediction system in accordance with one embodiment of the present invention.

FIG. 2 is a schematic illustration of transient heat transfer in a floating body.

FIG. 3 is a schematic illustration of transient heat transfer in a segment of a rail for a railroad track.

FIG. 4 is a line graph illustrating measured rail temperature and corresponding meteorological data.

FIG. 5 is a line graph illustrating the predicted rail temperature using the rail temperature prediction system in accordance with one embodiment, and the actual measured rail temperature.

FIG. 6 is a scatter graph illustrating the correlation between the predicted rail temperature and the actual measured rail temperature.

FIG. 7 is another line graph illustrating the predicted rail temperature and the actual measured rail temperature.

### DETAILED DESCRIPTION OF THE INVENTION

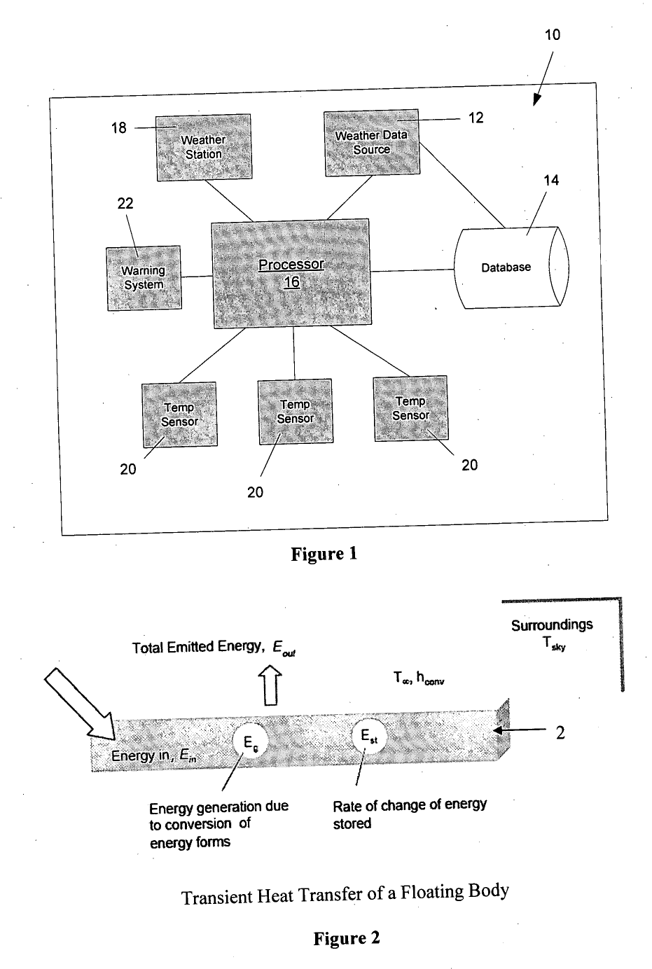

FIG. 1 shows a schematic illustration of a rail temperature prediction system 10 in accordance with one preferred embodiment of the present invention that can be used to predict future rail temperature. As will be evident from the discussion below, the prediction system 10 of the present invention utilizes meteorological data to predict the rail temperature in the future, i.e. at a given future time, while accounting for heat transfer characteristics of the rail. This allows various important future rail temperature information to be determined such as whether at any or what time, the rail temperature will exceed the temperature at which the rail may buckle, and/or the maximum rail temperature will occur. This allows the railroad companies to objectively, and more accurately, issue slow train operation orders so as to facilitate efficient utilization of the railroad, while reducing issuance of unnecessary slow orders.

As shown in FIG. 1, the rail temperature prediction system 10 includes a weather data source 12. The weather data source 12 may be commercial meteorological data sources that provide national and local meteorological data as well as weather forecast services. Commercial meteorological data sources typically use a meso-scale, high resolution, meteorological models for providing accurate weather forecasts for a particular geographical region. Such commercial meteorological data sources include those identified in National Oceanic & Atmospheric Administration's National Weather Service website http://www.nws.noaa.gov/im/more.htm. In this regard, the weather data source 12 of the described embodiment of the rail temperature prediction system 10 was implemented using commercial meteorological service MetWise™ which is a subsidiary of ENSCO, Inc., the assignee of the present invention. MetWise™ applies 12×12 kilometer weather grids to a geographical region, and provides meteorological data and forecasts for the grids.

It should be understood that the weather data source 12 provides geography specific current meteorological data, and also provides forecasts for the specific geographical region. Such forecasts are calculated and determined based on proprietary models used by the weather data sources. It should be further appreciated that whereas the weather data source 12 is schematically illustrated in FIG. 1 as being physically positioned with the other components of the rail temperature prediction system 10, such weather data source 12 may be remotely located in other implementations, and the meteorological data may be provided to the other components of the rail temperature prediction system 10 electronically, for example, via an electronic data feed.

The rail temperature prediction system 10 in accordance with the preferred embodiment of the present invention also includes a database 14 that retrievably stores the various meteorological data from the weather data source 12, including air temperature, wind condition, solar radiation, etc. The database 14 also retrievably stores the future weather forecast information that is also provided by the weather data source 12. Again, whereas the database 14 is schematically illustrated in FIG. 1 as being physically positioned with the other components of the rail temperature prediction system 10, the database 14 may alternatively be remotely located.

The rail temperature prediction system 10 further includes a processor 16 that processes the stored meteorological data received from the weather data source 12 to calculate and output a future rail temperature for a future time. As explained in further detail below, the processor 16 is implemented to calculate the future rail temperature, accounting for heat transfer characteristics of the rail which may include solar absorptivity of the rail, emissivity of the rail, specific heat of the rail, area of the rail surface, and/or volume of the rail. As also explained below, the processor 16 in the illustrated embodiment calculates the future rail temperature based on an energy equilibrium model for the rail, by determining a rate of change in rail temperature over time, and integrating the rate of change in rail temperature over time.

It should also be appreciated that the meteorological data and forecast information provided by the weather data source is for a particular geographical region. Correspondingly, the future rail temperature calculated by the processor 16 would be applicable to the particular geographical region as well since the future rail temperature is calculated by the processor 16 based on the meteorological data and forecast information.

This future rail temperature prediction capability of the rail temperature prediction system 10 correspondingly allows prediction of whether the rail temperature would be high enough in the geographical region so that rail buckling may occur, or the probability of the rail buckling is undesirably high. In this regard, the illustrated embodiment of the rail temperature prediction system 10 in FIG. 1 further includes a warning system 22 which is adapted to generate a warning signal based on the calculated future rail temperature provided by the processor 16. The warning system 22 may be implemented in any appropriate manner, for example, via computer software. A warning signal, i.e. warning information, may be generated if the processor 16 determines that the predicted future rail temperature for a geographical area being analyzed is sufficiently high enough to increase the likelihood of rail buckling, for example, will exceed a predetermined temperature. The generated warning signal can then be provided to rail transit and railroad officials who can use this information to issue slow orders objectively and reliably. For example, the warning signal that graphically illustrates a region where rail buckling may occur can be generated, or such information can be provided in text form with time when such buckling may occur.

In addition, to confirm and verify the accuracy of the meteorological data provided by the weather data source 12, and to enhance the accuracy of the predicted future rail temperature, an optional weather station 18 is provided in the illustrated embodiment of the rail temperature prediction system 10. The weather station 18 may be one or more commercially available weather stations that measures various meteorological data such as air temperature, wind condition, sun radiation, etc. Such information, if the weather station 18 is provided, may be stored in the database 14. The weather station 18 is located in the geographical region for which future rail temperature is to be predicted by the rail temperature prediction system 10.

Of course, the weather station 18 merely provides current weather conditions, and does not provide future forecast information such as the weather data source 12. However, the current meteorological data that is provided by the weather station 18 can be used by the processor 16 to calculate the future rail temperature instead of the current meteorological data that is also provided by the weather data source 12. This is advantageous since a locally positioned weather station 18 can provide current meteorological data for the immediate area near the rail and the railroad track rather than the wider geographical regional meteorological data that is provided by the weather station. Correspondingly, even more accurate prediction of the future rail temperature can be calculated by the processor 16.

In addition, the meteorological data from the weather station 18 can be used to verify the accuracy of the meteorological data and forecasts provided by the weather data source 12. Furthermore, forecast information from the weather data source 12 provided for the particular geographical region can be monitored over time and enhanced, if desired. If the weather data source 12 is found to be very inaccurate and/or inconsistent, a different vendor that provides more accurate meteorological data for the particular region can be sought.

In addition, in accordance with the preferred embodiment, the rail temperature prediction system 10 further includes a plurality of optional temperature sensors 20 that are secured to the rail (not shown) for measuring the actual temperature of the rail. In the illustrated example of FIG. 1, three temperature sensors are utilized for the rail. Such sensors may be any appropriate temperature sensors that are commercially available. The temperature information provided by the temperature sensors 20 (if provided) may also be stored in the database 14.

Of course, these temperature sensors 20 provide current rail temperatures, and cannot provide any predictions as to the rail temperature in the future which would be important for issuance of slow orders since such orders must be issued, disseminated, well before such orders can be effectively implemented. However, such temperature sensors 20 allows verification of proper functioning of the rail temperature prediction system 10. In particular, the temperature sensors 20 can be used to measure rail temperatures, and compare them to the previously predicted future rail temperatures to ensure that the rail temperature prediction system 10 is predicting the future rail temperature with sufficient accuracy.

If a substantial discrepancy is detected between the predicted future rail temperature and the actual measured temperature at the later time, the cause of the discrepancy can be investigated and corrected. In particular, in the illustrated embodiment, the discrepancy may be determined to be caused by inaccurate meteorological data from the weather data source 12, or be determined to be caused by location specific factors that require adjustments to the energy equilibrium model used to determine the future rail temperature. For example, a portion of the rail in a particular geographical area may be in a heavily wooded area which is shaded from sun exposure during the summer months, while being largely exposed to the sun during the other months, such variation requiring slight modification to the energy equilibrium model.

A rail temperature prediction system 10 in accordance with one embodiment described above was implemented and used to validate its function and ability to accurately predict future rail temperature at a future time. The technical model and approach selected in implementing the rail temperature prediction system 10 was based on quantifying the rail heating process in the open sun. Thus, real-time meteorological data provided by the weather data source 12 and rail related information, including the rails heat transfer characteristics, were used to calculate the future rail temperature.

As explained in further detail below, an energy equilibrium model was used in the implementation of the rail temperature prediction system 10 to allow the processor 16 to calculate the predicted rail temperatures about 9 hours in advance with sufficient accuracy to allow issuance of a slow order. In this regard, various weather data sources, including MetWise™, use meteorological models to provide fairly accurate forecasts 9 hours in advance, and provide updates every 30 minutes. Such meteorological forecasts allow future rail temperatures to be accurately calculated 9 hours in advance in accordance with the system and method of the present invention.

Of course, future rail temperatures can be calculated by the processor 16 for longer periods as well such as 24 hours in advance, or even longer periods since weather data sources 14 provide extended weather forecasts as well. However, since the accuracy and the level of confidence of the meteorological forecast diminishes as the forecast period into the future become longer, the accuracy of the resultant calculated rail temperature also decreases. Moreover, frequency of the updates can impact the accuracy of the calculated future rail temperatures, higher frequency of updates increasing the accuracy, albeit with diminishing returns beyond updating every 30 minutes.

The future rail temperature forecasting model implemented by the processor 16 in the illustrated embodiment of the rail temperature prediction system 10 is based on energy equilibrium and transient heat transfer of a finite floating body 2. This representation is shown in FIG. 2 which is a schematic illustration of transient heat transfer in a finite floating body. The general energy equilibrium for a floating body is represented by the following equation (1):

$${\dot{E}}_{in} + {\dot{E}}_{g} - {\dot{E}}_{out} = {\dot{E}}_{st} = \frac{ⅆ {E}_{st}}{ⅆ t} \qquad ( 1 )$$

where:

\dot{E}ᵢₙ—Rate of energy absorbed by the body from the sun;

\dot{E}ₒᵤₜ—Rate of total energy emitted from the body;

\dot{E}_{g}—Rate of energy generation due to conversion of energy forms; and

\dot{E}ₛₜ—Rate of change of energy stored.

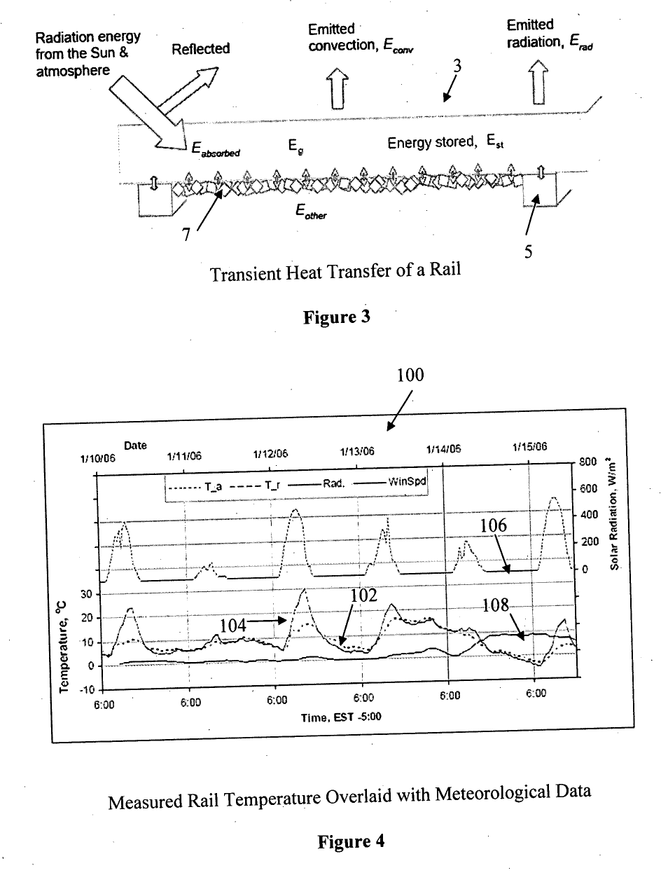

In contrast to the floating body of the above model, a rail does not completely float in the air. As shown in FIG. 3, the rail 3 is supported by interspersed ties 5, as well as the continuous crushed rock ballast 7. Thus, the above energy model is modified for a finite length rail 3 segment that sits on ties 5 and ballast 7 as shown in FIG. 3. The energy equilibrium for the rail element is thus represented by the equation (2):

$${\dot{E}}_{absorbed} + {\dot{E}}_{g} - {\dot{E}}_{out} = {\dot{E}}_{st} = \frac{ⅆ {E}_{st}}{ⅆ t} \qquad ( 2 )$$

where:

\dot{E}_{absorbed}—Rate of energy absorbed by the rail from the sun and atmosphere irradiation;

\dot{E}ₒᵤₜ—Rate of total energy emitted from the rail through conduction, convection and radiation;

\dot{E}_{g}—Rate of energy generation due to conversion of energy forms; and

\dot{E}ₛₜ—Rate of change of energy stored.

The energy that is radiated to the rail surface is partially reflected, and partially absorbed, by the rail. The portion that is reflected depends on rail surface Albedo which is in a range from 0 to 1. The portion that is absorbed depends on the rail surface's absorptivity, which is in a range from 0 to 1. For the purpose of the presently described implementation, it is presumed that there is no energy generation due to conversion of energy types. Thus, the energy equilibrium equation (2) can be reformulated as rail energy equilibrium equation (3):

$$k {α}_{s} {A}_{s} {G}_{s} cos θ - ( {h}_{conv} {A}_{c} ( {T}_{r} - {T}_{∞} ) + ɛσ {A}_{r} ( {T}_{r}^{4} - {T}_{sky}^{4} ) + {\dot{E}}_{other} ) = ρ cV \frac{ⅆ {T}_{r}}{ⅆ t} \qquad ( 3 )$$

where:
k—atmospheric filtering factor;
αₛ—solar absorptivity of rail;
Aₛ—area of rail surface exposed to the sun;
Gₛ—solar constant;
θ—solar angle;
h_{conv}—convection coefficient;
A_{c}—area of rail surface subject to convection heat transfer;
Tᵣ—rail temperature;
T_{∞}—ambient air temperature;
ε—emissivity of rail;
σ—Stefan-Boltzmann constant;
Aᵣ—area of rail surface subject to radiation heat transfer;
T_{sky}—atmospheric sky temperature above the cloud level;
\dot{E}ₒₜₕₑᵣ—a term to count for the heat exchange at interfaces of rail-tie and rail-ballast interfaces;
ρ—density of rail;
c—specific heat of rail; and
V—volume of rail.

Atmospheric filtering factor k is a parameter that gauges the percentage of solar constant (i.e. Gₛ) that can reach the earth's surface. It can be readily calculated using known estimation methods, and has value greater than 0 but less than 1. The solar constant Gₛ is the amount of incoming solar radiation per unit area with units watts/m², and is typically approximately 1366 watts/m², although this value can vary depending on the geography analyzed and the season. Solar angle (or solar zenith angle) θ indicates the elevation of the sun above the horizon in degrees, and can be calculated for a particular geographical region for any given time of day. It should be noted that the product of the filtering factor k, the solar constant Gₛ, and the solar angle θ may be provided by the weather data source 12 as a short wave solar radiation factor so that each of these factors and product thereof, need not be calculated.

Solar absorptivity αₛ of rail indicates the ability of the rail steel to absorb solar radiant energy. This value is available in various material property tables, and typically ranges from 0.75 to 0.85 for rail steel, 0.75 being used in the above described implementation. Variables Aₛ, A_{c}, and Aᵣ represent the area of rail surface subject to different heater transfer processes, and can be determined using rail sectional properties and known length of rail, 1 meter length in the present implementation, for which future temperature is being predicted. It is noted that the unit of area eventually cancels out in the above described rail energy equilibrium equation (3).

Convection heat-transfer coefficient h_{conv} is the amount of heat transfer between the rail and surrounding air, and is a function of various different factors. The convection heat-transfer coefficient can be measured or calculated. It should be noted that there is no standardized method for determining the value for different environment and heat transfer media. For the present implementation, the convection heat-transfer coefficient was determined using an empirical equation:

$${h}_{conv} = \{ \begin{matrix}a + {bv}_{win} & for {v}_{win} \leq 5 m / s \\ {c ( {v}_{win} )}^{0.78} & for {v}_{win} > 5 m / s\end{matrix} \qquad ( 4 )$$

where:

a=5.6;

b=4.0;

c=7.2; and

ν_{win}=wind velocity in m/s.

The above empirically modeled equation (4) was developed by the National Institute of Standards and Technology, and can be used to model the convection heat-transfer coefficient for steel. Of course, other models may be used in other implementations of the present invention to provide different convection heat transfer coefficient. However, empirical equation (4) has been found to be sufficiently accurate for use in predicting future rail temperature.

Emissivity of rail ε indicates the ability of the rail to radiate energy to the sky and the surrounding atmosphere. Emissivity is empirically determined and is available in various tables. Its value is material and temperature dependent, the values provided by the tables slightly varying based on the empirical findings. For steel rails, the value of emissivity ε is in the range of 0.65 to 0.85, depending on the surface condition of the rail. In the present implementation, emissivity ε=0.75 was used in the above rail energy equilibrium equation (3).

The variable T_{sky} is the atmospheric sky temperature above the cloud level, and is known to range from 0 to −60° C. below the ambient air temperature, depending the aerosols in the atmosphere, humidity etc. Presently, there is no simple equation to determine its value. Correspondingly, −20° C. below the ambient air temperature was used in the above rail energy equilibrium equation (3). Finally, for simplification, the heat exchange between the rail and ties, as well as ballast, was presumed to be negligible, i.e., \dot{E}ₒₜₕₑᵣ≈0. Finally, the rail density ρ and rail volume V was determined based on material properties of the rail and known rail shape and size.

The above rail energy equilibrium equation (3) provides the rate of change in the temperature of the rail over time. This can be integrated over time by the processor 16 to thereby derive the actual rail temperature at any given instant in time. In particular, as can be appreciated, equation (3) set forth above is a first order, nonlinear, non-homogeneous, ordinary differential equation. Correspondingly, it is solved by the processor 16 utilizing computational methods via tools such as commercially available computer programs, including Matlab™.

As can be appreciated, the energy balance model of the rail as described above is affected by weather conditions, rail's heat transfer properties including metallurgical properties, rail size and shape factors, and environmental parameters. As explained, the processor 16 processes the meteorological data in conjunction with the heat transfer characteristics of the rail to calculate and output a future rail temperature for a future time by determining a rate of change in rail temperature over time, and integrating the rate of change in rail temperature over time.

As noted, it was presumed that there is no energy generation due to energy conversion, and thus, such component was eliminated from the equation. As also noted, the energy exchange at bottom of the rail was presumed to be insignificant because the heat conductivity of wooden ties and rock ballast particles are far lower than that of steel. It was further presumed that during the time period when the rail temperature is higher than the ambient temperature and that of ballast and ties, the energy emitted from the rail to these components is substantially trapped at the contact surfaces. Thus, the net energy loss/gain at the interface of the bottom of the rail was also considered to be minimal.

Of course, all of the above noted parameters considered to be minimal and essentially equal to zero can be accounted for in other implementations of the rail temperature prediction system 10. However, accounting for such parameters increases the complexity of the analysis, and has been found to be unnecessary for the rail temperature prediction system 10 in order to predict the rail temperature with sufficient accuracy to allow for objective and accurate issuance of slow orders. The key to the present implementation was in establishing the relationship between the rail temperature and meteorological data. This has been demonstrated to be attainable without accounting for each and every parameter, and default inputs that are based on reasonable estimation and statistical analysis of the average railroad track conditions were used where appropriate.

As noted above, the rail temperature at the time of analysis (Tᵣ) is preferably based on temperature measurements from the optional temperature sensors 20. In other embodiments, if such temperature sensors are not used, the rail temperature can be assumed to substantially equal the ambient temperature at the time of analysis, or substantially equal to the ambient temperature at early morning when the rail temperature typically is the same as the ambient temperature. The subsequent rail temperatures for the prediction period, for example, the next 9 hours, can then be predicted based on the rail temperature, forecast ambient temperature and other meteorological data from weather data source 12, such as MetWise™ or other commercial weather forecast services.

The rail temperature prediction system 10 as schematically illustrated in FIG. 1 was implemented using the rail energy equilibrium model represented by the rail temperature prediction equation (3) described above. In implementing and testing the rail temperature prediction system 10, a short segment of railroad track was built in Springfield, Va. The track included two 5-ft 119 lb/yd rail, and three wooden ties that support the rails. The rails of the track were oriented northwest to southeast at about 30° from true north, and had rock ballast positioned between the ties and underneath the rails in the manner shown in FIG. 3.

MetWise™ was used as the weather data source 12 which provided current meteorological data and weather forecasts, and corresponding updates every 30 minutes. The optional weather station 18 for monitoring the accuracy of the meteorological data provided by MetWise™ was implemented using Wireless Vantage Pro 2 Plus Weather Station (Model 6163) that may be obtained from Davis Instruments of Hayward, Calif. The Vantage Pro 2 Plus includes a console and an integrated sensor suite (ISS) that houses, and manages, an external sensor array that measures actual weather conditions. The wireless ISS is solar powered with a battery backup, and is fan-aspirated, which combines passive shielding with a solar-powered fan that draws outside air in over the temperature and humidity sensors, thereby providing a much more accurate temperature reading than passive shielded stations. The Vantage Pro 2 Plus also includes a UV sensor and a solar radiation sensor. In the present implementation, the Vantage Pro 2 Plus was set to collect comprehensive weather data at one minute intervals.

The console of the Vantage Pro 2 provides the user interface, data display, A/D conversion, and calculations required to convert the outputs from the various sensors into weather data. The console may be powered by batteries or by an AC-power adapter. The ISS and console are implemented to communicate via an FCC certified, license-free, frequency hopping transmitter and receiver. User-selectable transmitter ID codes allow up to eight stations to coexist in the same geographic area. The frequency hopping spread spectrum technology provides greater communication strength over longer distances, and over areas of weaker reception. The WeatherLink™ software allows Vantage Pro 2 Plus to interface with a computer such as processor 16, to log weather data in database 14, and to upload weather information to a network, for example, the internet. Of course, whereas the described example embodiment of the rail temperature prediction system 10 included the optional local weather data station 18, other embodiments of the present invention may merely rely upon meteorological data provided by the weather data source 14 such as MetWise™.

The optional temperature sensors 20 of the rail temperature prediction system 10 were implemented using a Wireless Temperature Station (Model 6372) which includes a temperature probe and a wireless transmitter, the device being also available from Davis Instruments of Hayward, Calif. The temperature probe is a precision thermistor that produces a resistance change proportional to temperature, and is powered by a 3-volt lithium battery which can last up to 8 months. The wireless transmitter allows direct communication to the console/receiver of the Vantage Pro 2 Plus Weather Station over one of eight user-selectable ID codes, and has a transmitting range of between 75 to 300 meters, depending on the environment. Of course, other temperature sensors may be utilized in other implementations.

As explained, the use of plurality of rail temperature sensors 20 is optional, and the rail temperature prediction system 10 may be implemented without the plurality of rail temperature sensors 20. However, such plurality of temperature sensors 20 allow confirmation and verification of the accuracy of the future rail temperature that is calculated by the processor 16 as described previously. Moreover, where such optional rail temperature sensors 20 are used and measured rail temperatures are available, the instant rail temperature, along with current and forecast meteorological weather data can be utilized to more accurately predict future rail temperatures at predetermined time intervals, for example, 30 to 60 minutes intervals.

The rail temperature prediction system 10 was implemented to frequently update the predicted rail temperatures based on the current rail temperature as provided by the temperature sensors 20, current meteorological data as provided by the weather station 18, and updated weather forecasts as provided by the weather data source 12. As noted, if the optional temperature sensors 20 and the weather station 18 were not provided, the rail temperature could have been estimated using the meteorological data from the weather data source 12, which can then be used to predict future rail temperatures.

The optional temperature sensors 20 and the temperature sensor used by the weather data source 12, were calibrated by measuring air temperature indoors so that offsets and any correlation factors can be determined for each of the temperature sensors. After the calibration, the temperature sensors 20 were installed in the web of rails, and used to collect rail temperature at one minute intervals. Another temperature sensor was instrumented on a segment of another 140 lb/yd rail to measure rail temperatures for different rail orientations, and for different points of the rail to determine impact of such orientations and positions.

As noted, the data collection frequency was set at 1 minute. Upon examination of data collection for a certain period of time, it was found that longer collection interval up to 30 minutes would also be adequate. However, extended intervals would be less desirable for implementing the rail temperature prediction system 10 due to reduction in accuracy. The frequency in which meteorological data provided by weather data source 12 such as MetWise™ is updated is 30 minutes. Thus, the rail temperature prediction system 10 provided predictions in corresponding 30 minute intervals. Of course, if additional weather data sources were utilized, the rail temperature prediction system 10 may be implemented to provide predictions corresponding to the largest interval for the meteorological data received.

The console of the Vantage Pro 2 Plus Weather Station was connected to a development computer that served as the processor 16 and the database 14 of the rail temperature prediction system 10 schematically shown in FIG. 1. In this regard, the console/data logger received the data that is wirelessly transmitted from the weather station and the temperature sensors. This data was retrieved by the computer using the WeatherLink software, and uploaded into the memory of the computer that served as the database 14, the uploading occurring on an hourly basis in the present example implementation. The data collected from the above sensors and station were stored for examination and analysis in the described embodiment.

The rail temperature prediction system 10 of the present invention, as implemented in the manner described above, were utilized to predict and measure rail temperature over 100 days between November, 2005 and February, 2006. The measured rail temperatures, and the corresponding meteorological data for six of the days, are shown in graph 100 of FIG. 4. In graph 100, the ambient air temperature (T_a) is shown by dotted line 102, while the measured rail temperature (T_r) is shown by center line 104. The solar radiation measured (Rad.) is shown by dashed line 106, while the measured wind speed (WinSpd) is shown by solid line 108.

The six days illustrated in graph 100 of FIG. 4 included the following weather conditions:

Clear days with little wind: Jan. 10 & 12, 2006;

Generally overcast with litter wind: Jan. 11, 2006;

Cloudy day with little wind: Jan. 13, 2006;

Cloudy day with strong wind: Jan. 14, 2006; and

Clear day with strong wind: Jan. 15, 2006.

In graph 100, Jan. 10 and 12, 2006, were both clear days with little wind. A large difference between the ambient air temperature and the rail temperature were observed in these two days. In particular, on Jan. 10, 2006, the rail temperature reached 14.0° C. above the ambient temperature, reaching 24.4° C. when the ambient temperature only reached 10.4° C. Likewise, on Jan. 12, 2006, rail temperature reached 14.7° C. above the ambient temperature, reaching 30° C. when the ambient temperature only reached 15.3° C.

On Jan. 11, 2006, when it was overcast and less windy, the rail temperature was about the same as the ambient temperature. For the two cloudy days of Jan. 13 and 14, 2006, rail temperature was only a few degrees above the ambient temperature. On the clear and windy day of Jan. 15, 2006, the rail temperature was 9.9° C. above the ambient air temperature, the rail temperature reaching 14.4° C. when the ambient temperature only reached 4.5° C. As can be seen from the above comparison of the rail temperature and the ambient air temperature, heat transfer through radiation dominates the heat transfer process of the rail, while convection heat transfer provides the second largest contribution to the heat transfer process of the rail.

The rail temperature prediction system 10 was implemented to predict the rail temperature utilizing the energy equilibrium model as set forth in equations (2) and (3) discussed above. The processor performed the calculations for solving the energy equilibrium model equation utilizing the mathematical software program Matlab™. Of course, other mathematical tools may have been used in other implementations. The meteorological data that was collected by the weather data source 18 was utilized by the rail temperature prediction system 10 to retro-predict rail temperatures at different prediction intervals to demonstrate its function.

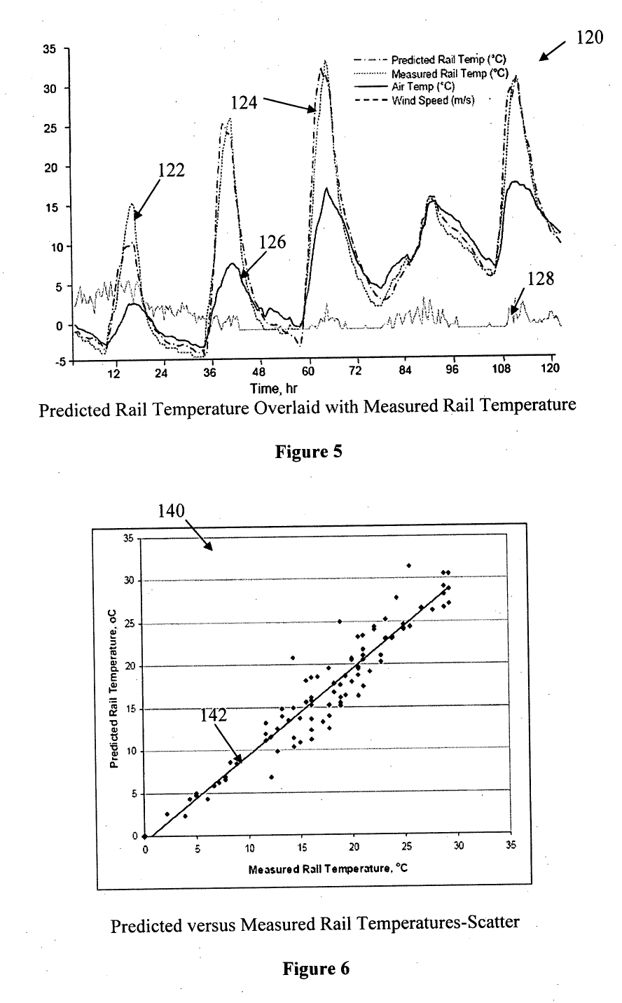

FIG. 5 shows a line graph 120 that illustrates the accuracy of the rail temperature prediction system 10 implemented in the manner described above. In particular, the line graph 120 illustrates the actual measured rail temperature shown by dotted line 122 as measured between Jan. 26 to 30, 2006. The rail temperature for these days as predicted by the rail temperature prediction system 10 described above is shown by the center line 124, the meteorological data being analyzed in 30 minute intervals. Line graph 120 also shows the ambient air temperatures (solid line 126) as well as the wind speed (dashed line 128). It is worth pointing out that on Jan. 28, 2006 which was a very mild day, the rail temperature reached approximately 33° C., which is approximately 16° C. above the ambient air temperature.

The correlation between the predicted peak rail temperatures, and the measured peak rail temperatures for 100 days during November 2005 to February 2006, are shown in the scatter graph 140 of FIG. 6. In particular, in the scattered graph 140, solid line 142 corresponds to the ideal, one-to-one correlation between the actual measured peak rail temperatures and the predicted peak rail temperatures as predicted by the rail temperature prediction system 10, i.e. perfect accuracy of the predicted peak rail temperature. The scattered data points graphically illustrate the deviation in the correlation of the predicted peak rail temperatures from the ideal, one-to-one correlation. As can be seen, the scattered data points are clustered close to the line 142, thereby indicating that in most instances, the rail temperature prediction system 10 predicted the peak rail temperatures that were very close to the actual measured rail temperatures.

As expected, the rail temperature prediction system 10, and the rail temperature prediction model used, predicts higher peak rail temperature for some days, while predicting lower peak rail temperature for some other days. There are likely to be various reasons for the above discrepancy. For instance, numerous other factors can influence the accuracy of the energy equilibrium model that is used by rail temperature prediction system, such as the difference between ambient temperature and sky temperature, rail orientation, rail surface condition, rail shape, and/or rail temperature gradient.

In particular, the energy equilibrium model described assumes that there is a constant difference between ambient temperature and sky temperature in calculating energy radiated from the rail to the sky. In reality, the sky temperature can be 60° C. below ambient temperature for clear sky conditions, or close to ambient temperature for overcast and rainy conditions. This difference between the sky and ambient temperatures also varies with latitude and seasons when the earth's axis tilted at different angles toward the sun. Correspondingly, improvements to the rail temperature prediction system 10, and the rail temperature model implemented therein, are possible by accounting for such differences. However, as previously noted, this increases cost and complexity of the rail temperature prediction system 10, while providing relatively small improvements in accuracy of the rail temperature prediction for the desired purpose of determining future rail temperatures for accurately issuing slow orders.

Furthermore, more frequent analysis intervals yielded better prediction results. For practical use of the rail temperature prediction system 10, analysis of the meteorological data in 30 minute intervals were found to be sufficient in predicting the rail temperature with enough accuracy to allow issuance of slow orders, although this interval may be modified in other embodiments.

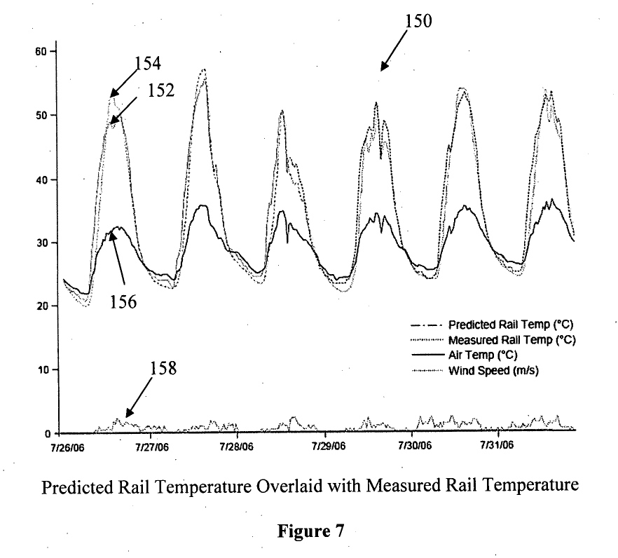

FIG. 7 shows a line graph 150 similar to that of FIG. 5 that illustrates the accuracy of the rail temperature prediction system 10 in which rail temperatures measured and predicted between Jul. 26 to 31, 2006 are compared. In particular, the line graph 150 illustrates the actual rail temperature shown by the dotted line 152, and the predicted future rail temperature is shown by center line 154, the meteorological data being analyzed in 30 minute intervals. Line graph 150 also shows the ambient air temperatures (solid line 156) as well as the wind speed (dashed line 158).

As can be seen, during the illustrated time period, ambient temperatures were high, reaching up to approximately 35° C. (approximately 95° F.). More importantly, the measured rail temperature was substantially higher, reaching up to approximately 55° C. (approximately 131° F.), which is a sufficiently high temperature so that the risk of rail buckling is also high, and thus, a slow order would be issued. This discrepancy of approximately 30° C. between the ambient temperatures and the measured rail temperature clearly demonstrates the inadequacy of issuing slow orders based on such ambient temperatures.

As also shown in the line graph 150, the predicted future rail temperature as shown by dashed line 154 clearly shows the relative accuracy of the rail temperature prediction system 10 in predicting the future rail temperature. While the predicted future rail Temperature as shown by dashed line 154 does not perfectly track the actual measured rail temperature shown by solid line 152, the predictions are sufficiently accurate to allow objective and accurate issuance of slow orders.

Thus, predicted temperatures that exceed a predetermined level can be flagged and a warning signal may be generated by the warning system 22. The warning signal may be used to graphically render on a graphical user interface, the possible danger regions where rail buckling may occur and the time in which such rail buckling may occur. Such information can be then used to objectively, and accurately issue slow orders. The warning may alternatively be sent as a message with specific information that may be used by the railroads in issuing a slow order, etc. As previously explained, providing of such warning signal by the warning system 22 is important since high temperatures increases the likelihood of the rail buckling, especially if the rail has been re-stressed for the winter season to reduce tensile stress and to lower the rail natural temperature with a rail plug.

Therefore, in view of the above discussion, it should be evident to one of ordinary skill in the art that the rail temperature prediction system 10 in accordance with the present invention allows prediction of rail temperature based on meteorological data and forecasts. In addition, as evidenced by the empirical data presented above, it should also be evident that the rail temperature prediction system 10 predicts rail temperature with sufficient accuracy to provide quantitative information for railroads to issue warnings and slow orders.

Thus, operation mangers, train dispatchers and maintenance mangers can issue such warnings and slow orders with higher degree of accuracy than presently possible. Correspondingly, issuance of unnecessary slow orders, and the manual verification process that result, can be substantially reduced by the rail temperature prediction system and method of the present invention, thereby reducing cost and underutilization of railroads. In addition, the present invention also allows such slow orders to be issued in conditions which would otherwise be not be issued based on presently used techniques for determining likelihood of rail buckling.

It should further be apparent that the present invention provides a novel a method for predicting future rail temperature for a rail of a railroad track. As evident from the discussion above, the method includes receiving current meteorological data, receiving forecasted meteorological data, and processing the received current and forecasted meteorological data to calculate a future rail temperature for a future time based on the meteorological data, accounting for heat transfer characteristics of the rail. The calculation the future rail temperature may include using an energy equilibrium model to determine a rate of change in rail temperature over time, and integrating the rate of change in rail temperature over time. The method may further include generating a warning based on the future rail temperature.

As also explained above, the method may further include periodically receiving updated forecasted meteorological data to update the calculated future rail temperature based on the updated forecasted meteorological data. Furthermore, in another embodiment, actual temperature of the rail may be measured, and used to update the predicted future rail temperature, or alternatively, processing the meteorological data to estimate current rail temperature, and using the estimated current rail temperature to calculate the future rail temperature.

Finally, it should also be evident from the discussions above that another aspect of the present invention is in providing a computer readable medium with instructions for implementing the system and/or method as described.

While various embodiments in accordance with the present invention have been-shown and described, it is understood that the invention is not limited thereto. The present invention may be changed, modified and further applied by those skilled in the art. Therefore, this invention is not limited to the detail shown and described previously, but also includes all such changes and modifications.

I/We claim:

1. A system for predicting future rail temperature for a rail of a railroad track, the system comprising:
at least one weather data source that provides current and forecasted meteorological data;
a database that retrievably stores the meteorological data from the at least one weather data source; and
a processor that processes the meteorological data to calculate and output a future rail temperature for a future time based on the meteorological data, accounting for heat transfer characteristics of the rail.

2. The system of claim 1, wherein processor calculates the future rail temperature by determining a rate of change in rail temperature over time, and integrating the rate of change in rail temperature over time.

3. The system of claim 1, further including a warning module adapted to generate a warning signal based on the calculated future rail temperature that is indicative of likelihood of the rail buckling at a future time.

4. The system of claim 1, wherein the at least one weather data source periodically updates the meteorological data, and the processor is further adapted to update the calculated future rail temperature based on the updated meteorological data.

5. The system of claim 1, wherein the heat transfer characteristics of the rail includes at least one of solar absorptivity of the rail, emissivity of the rail, specific heat of the rail, area of rail surface, and volume the rail.

6. The system of claim 1, wherein the processor calculates the future rail temperature further based on an energy equilibrium model for the rail.

7. The system of claim 6, wherein the processor calculates the future rail temperature by determining a rate of change in rail temperature over time in the energy equilibrium model, and integrating the rate of change in rail temperature over time.

8. The system of claim 7, wherein the energy equilibrium model for the rail is represented by equation:
$$k {α}_{s} {A}_{s} {G}_{s} cos θ - ( {h}_{conv} {A}_{c} ( {T}_{r} - {T}_{∞} ) + ɛσ {A}_{r} ( {T}_{r}^{4} - {T}_{sky}^{4} ) + {\dot{E}}_{other} ) = ρ cV \frac{ⅆ {T}_{r}}{ⅆ t}$$
where:
k—atmospheric filtering factor;
αₛ—solar absorptivity of rail;
Aₛ—area of rail surface exposed to the sun;
Gₛ—solar constant;
θ—solar angle;
h_{conv}—convection coefficient;
A_{c}—area of rail surface subject to convection heat transfer;
Tᵣ—rail temperature;
T_{∞}—ambient air temperature;
ε—emissivity of rail;
σ—Stefan-Boltzmann constant;
Aᵣ—area of rail surface subject to radiation heat transfer;
T_{sky}—atmospheric sky temperature above the cloud level;
\dot{E}ₒₜₕₑᵣ—a term to count for the heat exchange at interfaces of rail-tie and rail-ballast interfaces;
ρ—density of rail;
c—specific heat of rail; and
V—volume of rail.

9. The system of claim 1, further including at least one temperature sensor that measures the actual temperature of the rail at an instance in time.

10. The system of claim 9, wherein the processor is further adapted to update the predicted future rail temperature using the actual temperature measured.

11. The system of claim 1, wherein the processor is further adapted to process the meteorological data to estimate current rail temperature for use in calculation of the future rail temperature.

12. The system of claim 1, further including a weather station that verifies accuracy of the forecasts of the at least one weather data source.

13. A method for predicting future rail temperature for a rail of a railroad track comprising:
receiving current meteorological data;
receiving forecasted meteorological data; and
processing the received current and forecasted meteorological data to calculate a future rail temperature for a future time, accounting for heat transfer characteristics of the rail.

14. The method of claim 13, wherein calculating the future rail temperature includes determining a rate of change in rail temperature over time, and integrating the rate of change in rail temperature over time.

15. The method of claim 13, further including generating a warning based on the calculated future rail temperature to indicate the likelihood of the rail buckling at a future time.

16. The method of claim 13, further including periodically receiving updated forecasted meteorological data, and updating the calculated future rail temperature based on the updated forecasted meteorological data.

17. The method of claim 13, wherein the heat transfer characteristics of the rail includes at least one of solar absorptivity of the rail, emissivity of the rail, specific heat of the rail, area of rail surface, and volume the rail.

18. The method of claim 13, wherein calculation of the future rail temperature is attained using an energy equilibrium model for the rail.

19. The method of claim 18, wherein calculation of the future rail temperature includes determining a rate of change in rail temperature over time in the energy equilibrium model, and integrating the rate of change in rail temperature over time.

20. The method of claim 17, wherein the energy equilibrium model for the rail is represented by equation:
$$k {α}_{s} {A}_{s} {G}_{s} cos θ - ( {h}_{conv} {A}_{c} ( {T}_{r} - {T}_{∞} ) + ɛσ {A}_{r} ( {T}_{r}^{4} - {T}_{sky}^{4} ) + {\dot{E}}_{other} ) = ρ cV \frac{ⅆ {T}_{r}}{ⅆ t}$$
where:
k—atmospheric filtering factor;
αₛ—solar absorptivity of rail;
Aₛ—area of rail surface exposed to the sun;
Gₛ—solar constant;
θ—solar angle;
h_{conv}—convection coefficient;
A_{c}—area of rail surface subject to convection heat transfer;
Tᵣ—rail temperature;
T_{∞}—ambient air temperature;
ε—emissivity of rail;
σ—Stefan-Boltzmann constant;
Aᵣ—area of rail surface subject to radiation heat transfer;
T_{sky}—atmospheric sky temperature above the cloud level;
\dot{E}ₒₜₕₑᵣ—a term to count for the heat exchange at interfaces of rail-tie and rail-ballast interfaces;
ρ—density of rail;
c—specific heat of rail; and
V—volume of rail.

21. The method of claim 13, further including measuring an actual temperature of the rail.

22. The method of claim 21, further including updating the predicted future rail temperature using the measured actual temperature of the rail.

23. The method of claim 13, further including processing the meteorological data to estimate current rail temperature, and using the estimated current rail temperature to calculate the future rail temperature.

24. A computer readable medium with instructions for predicting future rail temperature for a rail of a railroad track, the computer readable medium comprising:
instructions for receiving current meteorological data;
instructions for receiving forecasted meteorological data; and
instructions for processing the received current and forecasted meteorological data to calculate a future rail temperature for a future time, accounting for heat transfer characteristics of the rail.

25. The computer readable medium of claim 24, further including instructions for determining a rate of change in rail temperature over time, and instructions for integrating the rate of change in rail temperature over time.

26. The computer readable medium of claim 24, further including instructions for generating a warning signal based on the calculated future rail temperature to indicate the likelihood of the rail buckling at a future time.

27. The computer readable medium of claim 24, further including instructions for periodically receiving updated forecasted meteorological data, and instructions for updating the calculated future rail temperature based on the updated forecasted meteorological data.

28. The computer readable medium of claim 24, wherein the heat transfer characteristics of the rail includes at least one of solar absorptivity of the rail, emissivity of the rail, specific heat of the rail, area of rail surface, and volume the rail.

29. The computer readable medium of claim 24, wherein instructions for calculating the future rail temperature is based on an energy equilibrium model for the rail.

30. The computer readable medium of claim 28, wherein instructions for calculating the future rail temperature includes instructions for determining a rate of change in rail temperature over time in the energy equilibrium model, and instructions for integrating the rate of change in rail temperature over time.

31. The computer readable medium of claim 28, wherein the energy equilibrium model for the rail is represented by equation:
$$k {α}_{s} {A}_{s} {G}_{s} cos θ - ( {h}_{conv} {A}_{c} ( {T}_{r} - {T}_{∞} ) + ɛσ {A}_{r} ( {T}_{r}^{4} - {T}_{sky}^{4} ) + {\dot{E}}_{other} ) = ρ cV \frac{ⅆ {T}_{r}}{ⅆ t}$$
where:
k—atmospheric filtering factor;
αₛ—solar absorptivity of rail;
Aₛ—area of rail surface exposed to the sun;
Gₛ—solar constant;
θ—solar angle;
h_{conv}—convection coefficient;
A_{c}—area of rail surface subject to convection heat transfer;
Tᵣ—rail temperature;
T_{∞}—ambient air temperature;
ε—emissivity of rail;
σ—Stefan-Boltzmann constant;
Aᵣ—area of rail surface subject to radiation heat transfer;
T_{sky}—atmospheric sky temperature above the cloud level;
\dot{E}ₒₜₕₑᵣ—a term to count for the heat exchange at interfaces of rail-tie and rail-ballast interfaces;
ρ—density of rail;
c—specific heat of rail; and
V—volume of rail.

32. The computer readable medium of claim 24, further including instructions for receiving an actual temperature of the rail.

33. The computer readable medium of claim 32, further including instructions for updating the predicted future rail temperature using the received actual temperature of the rail.

34. The computer readable medium of claim 24, further including instructions for processing the meteorological data to estimate current rail temperature, and instructions for using the estimated current rail temperature to calculate the future rail temperature.
